(19) United States
(12) Patent Application Publication
(10) Pub. No.: US 2011/0175425 A1
(43) Pub. Date: Jul. 21, 2011

(54) EMERGENCY LOCKING RETRACTOR

(75) Inventors: John Churilla, Riverside, CA (US); Bruce Campbell Glascock, Blue Jay, CA (US); Ronald John Nathan, Long Beach, CA (US); Luong Manh Trinh, Fullerton, CA (US)

(73) Assignee: PACIFIC SCIENTIFIC COMPANY, Duarte, CA (US)

(21) Appl. No.: 12/674,954

(22) PCT Filed: Oct. 22, 2008
(86) PCT No.: PCT/US2008/080724

§ 371 Date: Feb. 24, 2010

Related U.S. Application Data
(60) Provisional application No. 60/982,600, filed on Oct. 25, 2007.

(51) Int. Cl. B60R 22/343; B60R 22/36; B60R 22/405

(52) U.S. Cl. 297/478

(57) ABSTRACT

The present disclosure describes a dual mode emergency locking retractor (ELR) employing a mechanical strap acceleration sensing and locking mechanism in conjunction with an omni-directional housing acceleration sensing and strap locking system. The ELR utilizes a locking means responsive to the strap payout acceleration rate once a threshold rate of acceleration has been exceeded. The locking means terminates shaft rotation with a locking force which is proportional to the strap payout acceleration rate.

### CROSS REFERENCE TO RELATED APPLICATIONS

This application claims benefit as a continuation-in-part of U.S. Provisional Application No. 60/982,600, filed Oct. 25, 2007, the entire content of which is hereby incorporated by reference herein in its entirety for all purposes.

### FIELD OF THE INVENTION

The present disclosure relates to Emergency Locking Retractors (ELR) intended for use in safety restraint harnesses for moving vehicle occupant seats.

### BACKGROUND OF THE INVENTION

Reliable emergency locking retractors are an essential component of restraint systems for occupant seats in both air and ground vehicles. They permit freedom of motion in the upper body under normal circumstances, so the seat occupant can reach controls, retrieve dropped items, etc., but lock up and inhibit upper body movement when high accelerations such as those experienced in crashes occur.

All ELR include a spring-return shaft or spool around which a restraint system webbing is wrapped; supported at either end by a housing or frame. When unlocked, the shaft rotates as the webbing is pulled out, and the strap is automatically retracted when strap tension is removed by counter-rotation of the shaft due to spring-loading.

The better ELR are dual-mode, which sense or react to: a) acceleration of the restraint webbing strap payout from the ELR housing; and, b) acceleration in any direction of the ELR housing itself.

There are several dual-mode ELR available which utilize diverse technologies.

With respect to strap payout acceleration sensing and locking, one of the most common technologies used is a lagging inertial mass suspended via an adjustable spring on the shaft around which the restraint webbing is spooled. This inertial mass moves under shaft rotational acceleration as the webbing pays out and releases a spring-loaded locking dog that swings down and engages external teeth present on a disc which is also fixed to the rotating shaft. When the spring-loaded locking dog engages an external tooth, it stops shaft rotation.

A problem associated with this prior art locking mechanism is that it is independent of the strap payout acceleration. In other words, the locking mechanism is solely dependent on a locking spring and the force generated by the spring to displace the locking dog into contact with the external teeth. The prior art locking spring mechanism is therefore susceptible to the commonly known rebound or “skip lock” which can occur at high acceleration onset (i.e. rate of increase) levels.

While there are several different technologies used for housing acceleration sensing and locking, currently all are strictly mechanical in nature. One example is described in U.S. Pat. No. 5,636,807 which uses a mass suspended on two opposing sides by a series of spring-loaded levers whose axes of rotation are fixed to either the housing or to each other or to both. When the housing is accelerated, the mass moves with respect to the housing causing the levers to rotate such that a single repeatable output motion is produced to release the same locking dog described above for the strap locking portion.

### SUMMARY OF THE INVENTION

An emergency locking retractor (ELR) is disclosed comprising a mechanical strap acceleration sensing and locking mechanism that generates a locking force proportional to the rate of strap payout acceleration, to eliminate undesired skip-lock.

As is known in the prior art, an elongated strap is wound on a rotatable shaft or spool. A conventional power spring, retraction assembly or other means urges the strap to recoil about the shaft which is supported by a housing. The retraction assembly and rotatable shaft combination is referred to herein as a spring return rotatable shaft.

The term “strap payout” is used to define the displacement/unwinding of the strap from the reel. Strap payout can occur at essentially any rate of acceleration. However, the disclosed ELR requires a threshold or pre-determined rate of acceleration be exceeded in order to activate the locking means of the mechanical strap acceleration sensing and locking mechanism.

As will be discussed later, a spring means is used to provide an initial offsetting tension which, when overcome by an excessive strap payout acceleration rate, will cause locking engagement and terminate further shaft rotation and associated strap payout. A unique feature of the disclosed ELR is that the locking force for terminating shaft rotation is proportional to the strap payout rate of acceleration.

In a preferred embodiment, the mechanical strap acceleration sensing and locking mechanism can be adapted into a dual-mode ELR which further comprises a housing acceleration sensing and locking system which can be manufactured in mechanical, electrically passive or electrically active versions.

### Mechanical Strap Acceleration Sensing and Locking Mechanism

The mechanical strap acceleration sensing and locking mechanism comprises a spring-return shaft around which a restraint system webbing, sometimes referred to as a strap, is wrapped as is typical in prior art embodiments. However, the locking mechanism further comprises a locking means which, responsive to a pre-determined strap payout acceleration threshold having been exceeded, will impart a locking force which is proportional to the rate of strap payout acceleration. In other words, the greater the strap payout acceleration rate, the greater the locking force applied to terminate shaft rotation. This locking means is specifically designed to eliminate undesired skip-lock.

The locking means utilizes relative motion between a fixed disc secured to the shaft and an immediately adjacent inertial mass which is mounted upon, but free to rotate on the same shaft. Alternatively, if a spool is used to coil the strap, the face of the spool adjacent to the inertial mass could be designed to perform the same function as the fixed disc. For purposes of this disclosure, the term “fixed disc” can be a separate disc or it can be the modified side of a spool that faces the internal mass. Preferably, the inertial mass is a donut shaped disc which will be described later in detail.

The inertial mass and the fixed disc are operably connected to each other via an adjustable preloaded spring. When either the rotational acceleration of the shaft is high enough to overcome the connecting spring preload, or if the inertial mass is prevented from rotating by an external force as the shaft rotates (as will be discussed later under the electronic housing acceleration sensing and locking system section), the inertial mass effectively rotates with respect to the shaft fixed disc, causing at least one locking dog to move outward to engage teeth along the inner circumference of the housing adjacent to the shaft to prevent further shaft rotation.

The locking means comprises at least one recess rotatably secured to the shaft, preferably formed in the fixed disc secured to the shaft. Within each recess is partially disposed a locking dog. Each locking dog has an axially extending pin to engage the inertial mass as will be described later. The inner diameter of the retractor housing within which the shaft rotates, is partially configured with internal teeth for locking dog engagement when the locking means is activated.

Preferably, the locking means further comprises a spring means connecting the inertial mass to the shaft and thereby operably connecting the inertial mass to the fixed disc. The inertial mass is preferably disc-shaped and located near or on one end of the shaft. The preferred inertial mass embodiment comprises a substantially donut shaped configuration having an aperture appropriately sized for axial rotation about the shaft.

In one embodiment, the operable connection of the spring means to the shaft comprises a channel, slit or aperture located at the end of the shaft for engagement with one end of a spring. Preferably, this engagement is an end portion of the spring transversely disposed within the channel. The end portion of the spring is constructed of a sufficient material and thickness which will not deform under use conditions. The spring means comprises a spring housing having at least one external tab with a wounded coil of spring set within which is adapted for insertion within a recess of the inertial mass located adjacently near the shaft end. The recess includes a series of peripheral tab receiving notches for accepting the external tab which prevents the spring housing from rotating once seated within the recess.

The spring means is operably connected to the shaft and the spring housing is inserted within the recess located preferably on the top face of the inertial mass. Spring tension or spring pre-load can be adjusted by temporarily removing the spring housing from the recess and axially rotating it so the external tab will be inserted into a different notch while the spring means remains operably connected to the shaft by the end portion remaining within the channel, slit or aperture. Therefore, the spring means has a pre-determined level of tension when operably connected to said shaft and said inertial mass. Under this spring preload, the inertial mass is held in a position such that the locking dogs described below are pulled inward away from the internally toothed ring such that the ELR is in an unlocked condition.

With the shaft and inertial mass operably connected to one another by the pre-loaded spring, when the shaft begins to experience rotational acceleration due to strap payout, the inertial mass located about the shaft rotates in the same direction and at the same acceleration as the shaft because of the torque preload provided by the spring means. The torque required to keep the inertial mass accelerating at the same rate as the shaft is proportional to the rotational acceleration magnitude. Once strap payout acceleration and associated shaft rotational acceleration reach a predetermined triggering level, the torque required to continue accelerating the inertial mass will exceed the spring preload and the inertial mass will begin to accelerate less and lag behind the shaft.

As mentioned earlier, the locking means comprises at least one locking dog which will rotate from an open position to a locking position. Each locking dog has a locking end for engagement with either an internally-toothed ring fixed to the housing or a plurality of teeth formed along the inner circumference adjacent to the shaft. Each locking dog is located preferably in a respective recess near the outer periphery of the fixed disc, with axially protruding pins which are configured and positioned to fit into appropriately configured respective elongated slots located in the free-floating inertial mass adjacently located.

When the inertial mass lags behind the shaft as a result of excessive strap payout acceleration, the locking ends of the locking dogs are forced outward to frictionally engage the teeth to effect the lock. Once the strap acceleration drops below the triggering level and tension in the strap is relieved, the spring means causes the inertial mass to counter-rotate back and unlocks the ELR automatically (i.e. auto-resets) by forcing the locking dogs to retract to their initial at-rest positions.

### Housing Acceleration Sensing and Locking System

Disclosed is an electronic or mechanical housing acceleration sensing system which is operatively connected to a second locking means. One electronic version of this system can be programmed to recognize or sense whether a pre-determined rate of acceleration of the housing has been exceeded in any direction and employ an electro-mechanical actuator or solenoid to move a locking pawl, pinned to the housing, into frictional engagement with the inertial mass which is preferably modified to include a series of serrations equally distributed around its outer periphery.

Once the actuator moves the locking pawl into engagement, the inertial mass is prevented from further rotation and the strap cannot be pulled out without causing relative rotation between the shaft and inertial mass. The locking pawl engagement thus prevents further strap payout as described above for the strap locking mechanism, although the engagement is activated either by a spring and/or electro-mechanical actuator and is thus independent of housing acceleration rate.

The housing acceleration sensing system can be manufactured in mechanical, electrically passive or electrically active versions. The purpose of each of these versions is, responsive to sensing a triggering event, to activate a second locking means to terminate shaft rotation. The second locking means preferably comprises the modified inertial mass with serrated periphery, at least one locking pawl operably connected to a sensing unit where upon a triggering event being sensed, the locking pawl is displaced into frictional engagement with the serrated periphery causing the locking dogs discussed earlier to swing out and engage the inner circumferential teeth and terminate shaft rotation.

For the electrically active electronic embodiment, acceleration sensing for activating the actuator is actively accomplished by a MEMS (micro electro mechanical system), omnidirectional capacitive sensor, or equivalent, under control of an always-running micro-computer. The computer continuously monitors the MEMS output and, in the event the rate of ELR housing acceleration exceeds a predefined threshold, causes the actuator to react; and operatively move the locking pawl into frictional engagement with one of the serrations located on the perimeter of the inertial mass to effect a lock. This requires connection to the vehicle power system to maintain a continuous power supply for MEMS operation.

For the electrically passive embodiment, the MEMS and computer are replaced by a passive omnidirectional inertia switch, battery supply and latching type actuator to minimize battery drain.

It is to be noted that the force applied to the locking pawl to engage one of the outer periphery serrations is only required to be sufficient to overcome the spring preload and rotate the inertial mass with respect to the shaft the small distance necessary to displace the rotating locking dogs mentioned earlier for the Mechanical Strap Acceleration Sensing And Locking Mechanism into engagement. In other words, it is not necessary for the locking pawls and outer periphery serrations to provide frictional engagement to prevent strap payout themselves. It is only necessary to provide frictional engagement for inducing the rotating lock dogs into frictional engagement which will stop further strap payout. This required force can be provided by a spring loaded locking pawl.

Preferably, the electrically active embodiment is designed so when power is supplied to the actuator, the actuator will retract and pull the locking pawl away from serration engagement and unlock the ELR, thus permitting free strap payout. Then, when power is removed, or when polarity is reversed, depending on the embodiment, the actuator extends causing the locking pawl to engage one of the serrations and effect a lock.

For the electrically active embodiment, the actuator can be operated manually by means of an external control handle operably connected to the housing via an electrical control cable.

A control handle, remotely located from the ELR housing, is positioned for convenient use by the seat occupant and operably connected via an electrical cable. The control handle is used by the seat occupant to signal the computer to lock or unlock the ELR by removing or re-supplying power to the actuator. The seat occupant can actuate a plurality of electrical switches located within the control handle as the handle is moved in a prescribed direction. With this embodiment, the ELR can be manually locked at any time, but unlocking the ELR after a triggering locking housing acceleration event can be accomplished either automatically or manually, depending on how the computer is programmed.

In a triggering housing acceleration event using the electrically passive embodiment, all electrical power is supplied from an on-board battery pack. Additionally, the electro-mechanical actuator is of the magnetic latching type in order to conserve battery power. Acceleration sensing is accomplished by use of a passive omni-directional inertia switch. Unless and until power is supplied to the actuator, either by moving a control handle similar to that described above, or by closure of the contacts in the inertia switch due to a triggering acceleration, no power is required to maintain the ELR in either locked or unlocked mode, thus greatly prolonging battery life. The ELR is unlocked by momentarily supplying positive-polarity power to the actuator such that it retracts and pulls the locking pawl free of the floating mass serrations and magnetically latches in this retracted position. Locking occurs when reverse-polarity power is momentarily supplied to the actuator to release the magnetic latch and allow a spring to move the locking pawl into the locking position.

In a further alternative embodiment utilizing battery power, manual control, rather than relying upon a computer to determine when to unlock the ELR is presented. For manual control, switches within the control handle are momentarily opened or closed as the handle is moved from one position to another to supply positive or reversed polarity power to the actuator as described above to manually lock or unlock the ELR, while for automatic locking when in the unlocked condition during a high acceleration event, the inertia switch contacts close for the duration of the event, usually quite short, supplying the reverse polarity power required to unlatch the actuator and effect the lock. With this embodiment, unlocking the ELR after a triggering locking housing acceleration event requires manual operation of the control handle.

For the mechanical housing acceleration sensing and locking embodiment, a tipping and translating mass mechanism, whose housing is fixed to the ELR housing, moves in response to ELR housing acceleration in any direction to lift a single spring-loaded lever so as to cause a locking pawl pinned to the ELR housing to engage the serrations on the outer periphery of the floating mass described above to effect the lock as described above. With this embodiment also, unlocking the ELR after a triggering locking housing acceleration event requires manual operation of the control handle. The remote control handle in this case actuates a mechanical push-pull control cable connected between control handle and ELR.

### DESCRIPTION OF THE DRAWINGS

FIG. 1 is an exploded view of the locking mechanism.

FIG. 2 illustrates a representation end view of the locking mechanism.

FIG. 3 is a representative end view illustrating free strap movement with dogs retracted.

FIG. 4 is a representative end view illustrating the mechanical strap acceleration sensing and locking mechanism preventing strap movement with dogs engaged.

FIG. 5 is a representative end view illustrating an electronic housing acceleration sensing and locking system in unlocked mode allowing free strap movement.

FIG. 6 is a representative end view illustrating an electronic housing acceleration sensing and locking system in locked mode preventing free strap movement.

FIG. 7 is a block diagram illustrating the relationship of the control elements of the electrically active housing acceleration sensing and locking system.

### BEST MODE FOR CARRYING OUT THE INVENTION

The emergency locking retractor (ELR) comprises a mechanical strap acceleration sensing and locking mechanism which can be modified into a dual-mode ELR further comprising a housing acceleration sensing and locking system.

### Mechanical Strap Acceleration Sensing and Locking Mechanism

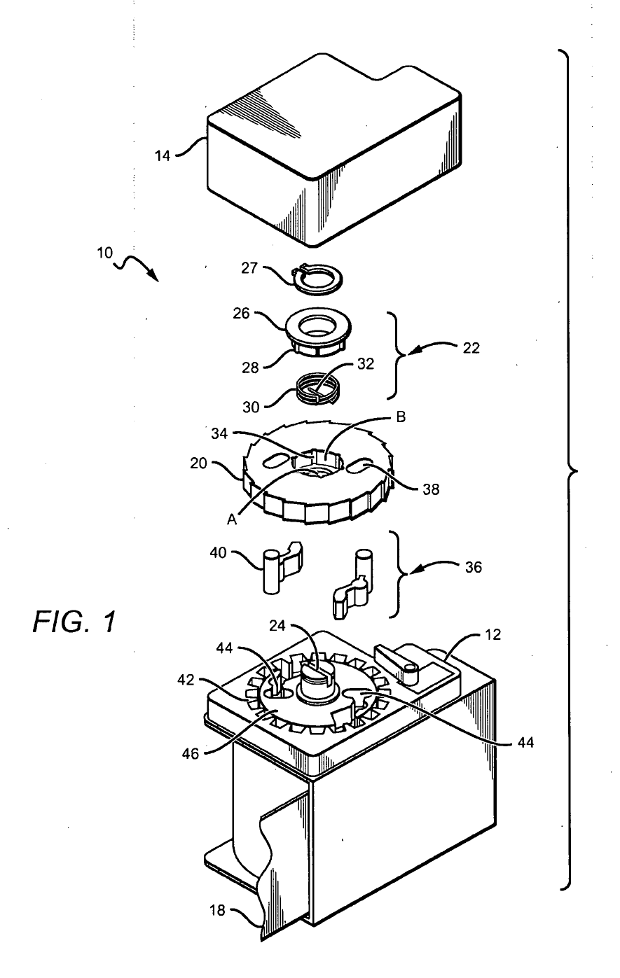

FIG. 1 provides an exploded view of the ELR 10. ELR 10 is positioned within housing 12 and cover 14.

Within housing 12 is a spring-return shaft 16 supported by the housing at each end. About shaft 16 is spooled a restraint system webbing or strap 18 having a proximal end secured thereto. The distal end of strap 18 exiting housing 12 is typically attached to the shoulder harness of a seat occupant restraint system. A retraction assembly is operably connected to shaft 16 and automatically retracts strap 18 back into housing 12 when it is pulled out and subsequently released. A locking means is provided which comprises a free-floating disc-shaped inertial mass 20 located about one end of shaft 16, a spring means 22 and a pair of locking dogs 36 as will be discussed later.

Inertial mass 20 comprises a substantially donut shaped configuration having an aperture A appropriately sized for axial rotation about the shaft 16. Inertial mass 20 is rotatably mounted upon shaft 16 and the shaft end and inertial mass 20 are both configured to be operably connected to one another by a spring means 22.

The operable connection of spring means 22 to shaft 16 comprises a channel 24 provided for at the end of shaft 16. Spring means 22 comprises a spring housing 26 having at least one external tab 28 and a coiled spring 30 set within. Spring 30 is configured for one end 32 to be disposed within channel 24 thus operably connecting spring means 22 to shaft 16. The other end of spring 30 is attached to the spring housing 26. The end portion 32 of spring 30 is constructed of a sufficient material and thickness which will not deform under use conditions.

Spring housing 26 is appropriately sized for snug insertion into a recess B having a plurality of tab-receiving notches 34 formed in inertial mass 20 for accepting external tabs 28 of spring housing 26. A locking ring 27 is used to secure spring means 22 within recess B.

Tension on spring means 22 can be adjusted by temporarily removing spring housing 26 from recess B and axially rotating so external tabs 28 will be aligned and inserted into a different tab-receiving notch 34 while spring means 22 remains operably connected to shaft 16 by spring end 32 remaining within channel 24.

The locking means includes a locking dog recess 44 and inertial mass 20 having a pair of elongated slots 38 for receiving a respective elongated pin 40 of locking dog 36 and a plurality of inner teeth 42 about the inner diameter of housing 12.

With shaft 16 and inertial mass 20 operably connected to one another by spring means 22, when shaft 16 begins to experience rotational acceleration due to strap payout, inertial mass 20 will rotate in the same direction and at the same acceleration as shaft 16 because of the torque preload provided by spring means 22. The torque required to keep inertial mass 20 accelerating at the same rate as shaft 16 is proportional to the rotational acceleration magnitude. Once strap payout acceleration and associated shaft rotational acceleration reach a predetermined triggering level, the torque required to continue accelerating inertial mass 20 will exceed the spring preload and inertial mass 20 will begin to accelerate less and lag behind (i.e., rotate with respect to) the shaft 16.

Adjacent and attached to one side of the spring return-reel attached about shaft 16 is an enlarged disc 46 of a sufficient thickness for locking dog recesses 44. Each recess contains a respective locking dog 36. Each locking dog 36 has an engagement end 48 for engagement with inner teeth 42 fixed to housing 12.

FIG. 2 illustrates an end view showing the orientation of the locking means when not activated. The spring pre-load tension on spring means 22 urges inertial mass 20 into the position shown; specifically where elongated pin 40 of locking dog 36 is located at the outermost most position in elongated slot 38 away from shaft 16.

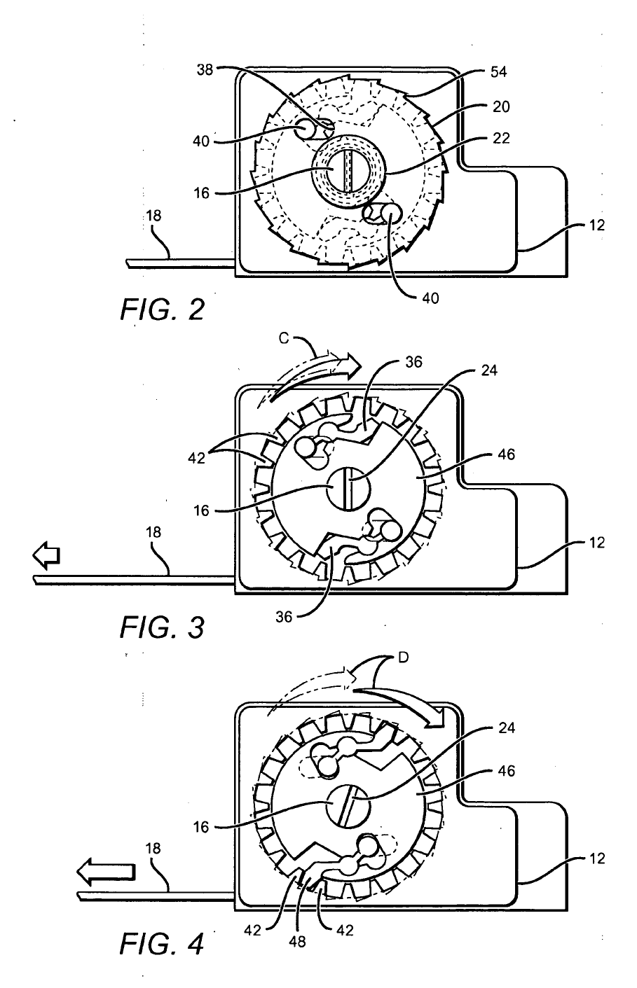

FIG. 3 illustrates the locking dog arrangement when the strap payout acceleration is not excessive as indicated by arrows C. Each locking dog 36 remains in the position shown in FIG. 2.

When inertial mass 20 lags behind shaft 16 as a result of excessive strap payout acceleration represented by arrows D in FIG. 4, the elongated pins 40 of locking dogs 36 displace within slots 38 thus forcing engagement ends 48 outward past the periphery of enlarged disc 46 to engage inner teeth 42 to effect the lock. Once the strap acceleration drops below the triggering level and tension in the strap is relieved, spring means 22 causes inertial mass 20 to counter-rotate back and unlock the ELR automatically (i.e. auto-resets) by forcing locking dogs 36 to return to their initial at-rest positions as shown in FIG. 2.

### Housing Acceleration Sensing and Locking System

As stated earlier, the emergency locking retractor (ELR) comprises a mechanical strap acceleration sensing and locking mechanism which can be adapted into a dual-mode ELR. This modification is a housing acceleration sensing and locking system which comprises a housing acceleration sensing system and portions of the mechanical strap acceleration sensing and locking mechanism to effect the locking engagement.

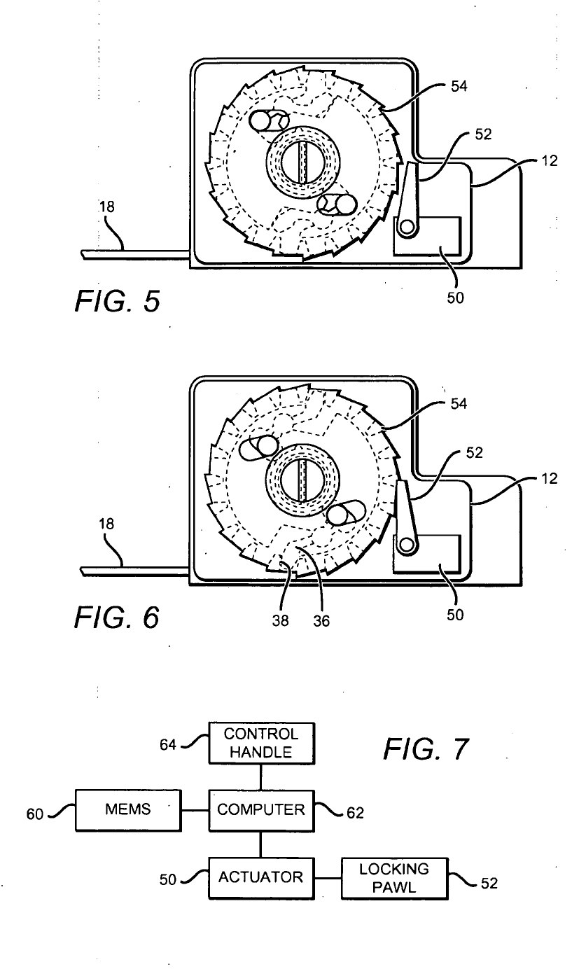

The electronic housing acceleration sensing and locking embodiments (i.e. passive and active) employ an electro-mechanical actuator 50 to move a locking pawl 52 pinned to housing 12 and spring-loaded for frictional engagement with one of a plurality of serrations 54 distributed around the outer periphery of inertial mass 20. FIG. 5 illustrates the condition prior to an acceleration event.

Upon an acceleration triggering event, the electronically active embodiment, which utilizes a MEMS 60 and computer 62 operably connected to electro-mechanical actuator 50 depicted in FIG. 7, cuts power to actuator 50 causing locking pawl 52 to rotate and engage with one of serrations 54 as illustrated in FIG. 6. This engagement causes elongated pin 40 to displace within slot 38 causing engagement end of locking dog 36 to frictionally engage inner teeth 42 and prevent further strap payout.

Afterwards, when power is supplied to actuator 50, it retracts and pulls locking pawl 52 away from serrations 54 and permits free strap payout.

A control handle 64 remotely located in a convenient position for use by a seat occupant and connected to the ELR housing via an electrical cable 66, is used to signal computer 62 to lock or unlock the ELR by removing or re-supplying power to actuator 50, by virtue of actuating a plurality of electrical switches within the control handle 64 as the handle is moved in a prescribed direction. With this embodiment, unlocking the ELR after a triggering locking housing acceleration event can be accomplished either automatically by computer 62 or manually by the operator using the control handle 64.

In the electrically passive embodiment, the MEMS accelerometer 60 and computer 62 are replaced by a passive omni-directional inertia switch and battery pack (not shown), and the actuator 50 is of the magnetic latching type to conserve battery power. With this embodiment, unlocking the ELR after a housing acceleration locking event must be accomplished manually via the control handle 64.

In the mechanical housing sensing and locking embodiment, the MEMS 60, computer 62 and actuator 50 are replaced by a tipping and translating mass mechanism (not shown), whose housing is fixed to the ELR housing, and which moves in response to ELR housing acceleration in any direction to lift a single spring-loaded lever (not shown) so as to cause a spring-loaded locking pawl 52 pinned to the ELR housing to engage the serrations 54 on the outer periphery of the floating mass 20 as described above to effect the lock as described above. With this embodiment also, unlocking the ELR after a triggering locking housing acceleration event requires manual operation of the control handle 64. The remote control handle 64 in this case actuates a mechanical push-pull control cable connected between control handle 64 and ELR 10.

We claim:

1. An emergency locking retractor comprising:
a spring return rotatable shaft supported by a housing;
an elongated strap wrapped around said shaft;
said elongated strap capable of strap payout and subsequent retraction; and,
a locking means responsive to the strap payout rate of acceleration once a threshold rate of strap payout acceleration has been exceeded, to terminate rotation of said shaft with a locking force which is proportional to said strap payout rate of acceleration.

2. The emergency locking retractor of claim 1 wherein said locking means comprises:
a disc secured to said rotatable shaft and an inertial mass rotatably mounted to said rotatable shaft and adjacent to said disc; said disc further comprising at least one locking dog recess formed in the surface of said disc facing said inertial mass, said inertial mass further comprising at least one elongated slot and a spring means recess having peripheral tab receiving notches;
a spring means operably connected to said rotatable shaft and to said inertial disc mass;
said housing further having an inner diameter within which said shaft, said inertial mass and said disc are rotatable, the periphery of said inner diameter configured with engaging teeth; and,
at least one locking dog partially disposed within a respective said locking dog recess and having an axially extending pin for engaging a respective elongated slot of said inertial mass; said at least one locking dog rotatable outward, once a threshold rate of acceleration has been exceeded, into frictional engagement with said engaging teeth of said housing.

3. The emergency locking retractor of claim 2 wherein said spring means comprises a spring connected to said shaft and an external spring housing having at least one external notch for engagement with a respective one of said peripheral tab receiving notches, said spring means having a pre-determined level of tension when operably connected to said shaft and said inertial mass.

4. The emergency locking retractor of claim 1 further comprising a housing acceleration sensing system responsive to the rate of acceleration of said housing in any direction once a threshold rate of housing acceleration has been exceeded to activate a second locking means to terminate rotation of said shaft.

5. The emergency locking retractor of claim 2 further comprising a housing acceleration sensing system operatively connected to said at least one locking dog, said electronic housing acceleration sensing system responsive to the rate of acceleration of said housing in any direction once a threshold rate of housing acceleration has been exceeded to cause said at least one locking dog to frictionally engage said engaging teeth of said housing.

6. The emergency locking retractor of claim 4 where said housing acceleration sensing and locking system further comprises a remotely located control handle, operably connected to allow manual locking and unlocking of said rotatable shaft.

7. The emergency locking retractor of claim 5 where said housing acceleration sensing and locking system further comprises a remotely located control handle, operably connected to allow manual locking and unlocking of said rotatable shaft.

8. An emergency locking retractor according to claim 4 or 5 where said housing acceleration sensing and locking system is mechanical, electrically passive or electrically active.

9. An emergency locking retractor comprising:
a spring return rotatable shaft supported by a housing;
an elongated strap wrapped around said shaft;
said elongated strap capable of strap payout and subsequent retraction; and,
a locking means responsive to the strap payout rate of acceleration once a threshold rate of strap payout acceleration has been exceeded, to terminate rotation of said shaft with a locking force which is proportional to said strap payout rate of acceleration, said locking means comprising a disc secured to said rotatable shaft and an inertial mass rotatably mounted to said rotatable shaft and adjacent to said disc; said disc further comprising at least one locking dog recess formed in the surface of said disc facing said inertial mass, said inertial mass further comprising at least one elongated slot and a spring housing recess having peripheral tab receiving notches;
a spring operably connected on one end to said rotatable shaft and to said inertial disc mass and on the other end to an external spring housing having at least one external notch for engagement with a respective one of said peripheral tab receiving notches;
said housing further having an inner diameter within which said shaft, said inertial mass and said disc are rotatable, the periphery of said inner diameter configured with engaging teeth; and,
at least one locking dog partially disposed within a respective said locking dog recess and having an axially extending pin for engaging a respective elongated slot of said inertial mass; said at least one locking dog rotatable outward, once a threshold rate of acceleration has been exceeded, into frictional engagement with said engaging teeth of said housing.
